(19) United States
(12) Patent Application Publication
(10) Pub. No.: US 2015/0207872 A1
(43) Pub. Date: Jul. 23, 2015

(54) METHOD AND SYSTEM FOR PERFORMING MOBILE CDN REQUEST ROUTING

(71) Applicant: NEC Europe Ltd., Heidelberg (DE)

(72) Inventors: Martin Stiemerling, Leimen (DE); Jan Seedorf, Heidelberg (DE)

(21) Appl. No.: 14/421,164

(22) PCT Filed: Aug. 21, 2012
(86) PCT No.: PCT/EP2012/066229

§ 371 Date: Feb. 12, 2015

(51) Int. Cl. H04L 29/08; H04W 24/02; H04M 15/00

(52) U.S. Cl. CPC H04L 67/1014; H04L 67/2842; H04M 15/66; H04W 24/02

(57) ABSTRACT

A method for performing mobile CDN request routing includes receiving, from a user terminal attached or subscribed to a communication network, a content request initiated by the user terminal towards a mobile content delivery network (mCDN). The content request is processed within the mCDN by selecting a cache at which the requested content is available. Internal mCDN request routing decisions are determined based on control plane information from the network core of the communication network.

### CROSS-REFERENCE TO PRIOR APPLICATIONS

This application is a U.S. National Phase application under 35 U.S.C. §371 of International Application No. PCT/EP2012/066229, filed on Aug. 21, 2012. The International application was published in English on Feb. 27, 2014 as WO 2014/029419 under PCT Article 21(2).

### FIELD

The present invention relates to a method for performing mobile CDN request routing, wherein a user terminal being attached and/or subscribed to a communication network initiates a content request towards a mobile content delivery network (mCDN), and wherein said content request is processed within said mCDN by selecting a cache at which the requested content is available.

Furthermore, the present invention relates to a system for performing mobile CDN request routing, comprising a communication network including a network core, a mobile content delivery network (mCDN), and a user terminal being attached and/or subscribed to said communication network and being configured to initiate content request towards said mCDN, wherein said mCDN is configured to process said content requests by selecting a cache at which the requested content is available.

### BACKGROUND

Content delivery networks (CDNs) are large distributed computer systems that consist of autonomous servers deployed in multiple data centers in the Internet. CDNs are operated and managed by service providers with the goal to provide content to end-users with high availability and high performance. In this context content delivery typically includes the storage, caching, or transmission of content, like e.g. streaming media or applications.

Current Content Delivery Networks (CDNs) try to optimize CDN request routing, i.e. the process of redirecting an end user request to the best suitable cache location in the network, on the one hand based on the location of the end-user initiating a content request (e.g. its IP-address) and on the other hand based on internal information about the Content Delivery Network (such as load on caches, network topology, and content placement among caches). For instance, an existing CDN may aim at redirecting a user to the closest cache which has the content and which is not significantly overloaded.

However, very few optimizations today are related to mobile CDN request routing, i.e. cases where a CDN is deployed within a mobile network (mCDN).

Very recently, Akamai and Ericsson have announced a solution called “Mobile Cloud Accelerator (MCA)”. With this solution, the CDN system can trigger QoS and bearer features in the mobile network. Thus, the CDN can influence mobile network settings for optimized delivery of content to users (e.g. for premium content for which the CDN gets revenue from the content owner for fast and reliable delivery). The goal of this state-of-the-art approach is to optimize the actual delivery of the content between the CDN cache and the user's terminal. However, optimization of the CDN internal request routing process is not addressed.

### SUMMARY

In an embodiment, the present invention provides a method for performing mobile CDN request routing including receiving, from a user terminal attached or subscribed to a communication network, a content request initiated by the user terminal towards a mobile content delivery network (mCDN). The content request is processed within the mCDN by selecting a cache at which the requested content is available. Internal mCDN request routing decisions are determined based on control plane information from the network core of the communication network.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a schematic view illustrating signaling interfaces between a mobile core and a mobile CDN system,

FIG. 2 illustrates a schematic view illustrating an attribute request model for an mCDN to access mobile network control plane information according to an embodiment of the present invention, and

FIG. 3 illustrates a schematic view illustrating an architecture for taking charging information into account within a cache selection algorithm according to a further embodiment of the present invention.

### DETAILED DESCRIPTION

In an embodiment, the present invention provides a method and a system of the initially described type for performing mobile CDN request routing in such a way that the process of making effective and optimized request routing decisions is improved.

According to an embodiment, a method includes taking into consideration, control plane information from the network core of said communication network, for making internal mCDN request routing decisions.

Furthermore, according to an embodiment, a system includes a mCDN with a control function configured to collect control plane information from said network core and to take into consideration said control plane information for making internal mCDN request routing decisions.

According to an embodiment of the invention, it has been recognized that, considering the capabilities and characteristics of mobile networks and, in particular, considering the case where a CDN is deployed within a mobile network (mCDN), optimizations for CDN request routing are possible if the mobile network provides certain information about an end user to the mCDN. The embodiment of the present invention targets such optimizations and proposes the specific provisioning of mobile network control plane (C-plane) information to a mobile CDN with the purpose of improving CDN internal request routing, in particular best cache selection, based on such information. For instance, the embodiment of the invention enables fine grained dynamic adaptation of CDN internal routing based on subscription specifics. The embodiment of the invention is generic in nature and can in principle be applied to many different kinds of mobile CDN systems.

Compared to current CDNs, which are focusing on fixed networks and are just starting to explore the integration of mobile networks and CDNs, the method and system according to the present invention achieve a core benefit by making use of such interaction: optimized CDN request routing based on suitable mobile core C-Plane information. If current CDNs focus on mobile networks, they are basically only considering the capabilities of the UE, e.g., what is the maximum screen size of the particular UE for the content playout.

According to a preferred embodiment, the communication network may be a mobile communication network comprising a mobile core network. However, the embodiments of the invention may also be applied to other types of communication networks, such as, but not limited to, fixed-line networks, as long as these networks provide control plane information, or similar information.

In a specific embodiment, the mCDN may include a delivery function (hereinafter to briefly denoted as DF), which may be configured to solicit information related to a content requesting user terminal. In this regard it may be provided that a user terminal, upon initiating an initial contest request towards the mCDN, gets assigned the DF as entry point into said mCDN. The DF may then query control plane information from the network core through proprietary and/or through existing standard interfaces.

With regard to the control plane information it may be provided that this information includes information related to or specific to the content requesting user terminal, e.g. a mobile subscriber. In particular, policy and/or charging information about the respective user may be solicited, as will be explained in more detail below.

According to one embodiment, the control plane information may include information related to granted and/or negotiated QoS of the content requesting user terminal. For instance, the QoS information may be provided in form of a respective information element (“QoS IE”). In a mobile communication network according to a 3GPP architecture this QoS related information would be available at the serving/gateway General packet radio service Support Node (xGSN), which is a node that integrates the functions of the SGSN (Serving General packet radio service Support Node) and the GGSN (Gateway General packet radio service Support Node). Alternatively or additionally, the control plane information may include information related to granted QoS in form of “EPS (Evolved Packet System) Bearer QoS” which, e.g. in a 3GPP architecture, would be available at the MME (Mobility Management Entity), at the SGW (Serving Gateway), and/or at the PGW (PDN Gateway).

According to a further embodiment, the control plane information may include information related to subscribed QoS of the content requesting user terminal. Specifically, this information may be provided in form of subscribed UE AMBR (User Equipment Aggregate Maximum Bit Rate), subscribed APN (Access Point Name) AMBR and/or EPS subscribe QoS profile. In a 3GPP architecture all this information would be available either at the MME or at the HSS (Home Subscriber Server).

According to a still further embodiment, the control plane information may include information related to subscribed charging characteristics of the content requesting user terminal. Specifically, this information may be provided in form of EPS Subscribed Charging Characteristics, i.e. for instance normal, prepaid, flat-rate or hot billing subscription. Again, in a 3GPP architecture this information would be available either at the MME or at the HSS. Alternatively or additionally, this information may be provided in form of EPS PDN Subscribed Charging Characteristics, i.e. for instance normal, prepaid, flat-rate or hot billing subscription. In a 3GPP architecture this information would be available at the MME, HSS, SGW, and/or PGW.

Advantageously, subscriber information about a content requesting user terminal are employed by said mCDN to retrieve policy and/or charging information about the user terminal, preferably via the PCRF (Policy and Charging Rules Function) of a mobile core of the communication network. The mobile network Application Function (AF) (an element offering applications that require dynamic policy and/or charging control over the “IP CAN”, i.e. the association between a UE and an IP network) can retrieve user information based on an UE's IP address, as described in 3GPP TS 23.203 V11.5.0 (2012-03): “3rd Generation Partnership Project; Technical Specification Group Services and System Aspects; Policy and charging control architecture (Release 11)”. Therefore, the AF could be a function within the mCDN, e.g. the DF. This AF could (via regular 3GPP interfaces) get the above mentioned subscriber information about a UE based on the UE's IP-address.

According to a preferred embodiment, the control function implemented within the mCDN may include a cache selection function and a content lookup function. The content lookup function may be configured to receive from a central content database information about which cache stores requested content. This information may then be forwarded to the cache selection function, which may then fetch information about the status of those caches which store requested content. In particular, it may be provided that the cache selection function is configured to fetch topology and/or policy information about those caches which store requested content, preferably by contacting an ALTO server.

According to a preferred embodiment, the cache selection function implemented within the mCDN combines and/or aggregates information related to the content requesting user terminal with internal information about the mCDN, in particular cache specific information, such as load on caches, content placement among caches, and network topology. For instance, one example for aggregating such information could be a weighted sum which can balance conflicting interests in a controllable way. However, as will be appreciated by those skilled in the art various methods for combining and/or aggregating information can be employed depending on the particular circumstances. The thus generated combined and/or aggregated information may then be used by an algorithm for best cache selection.

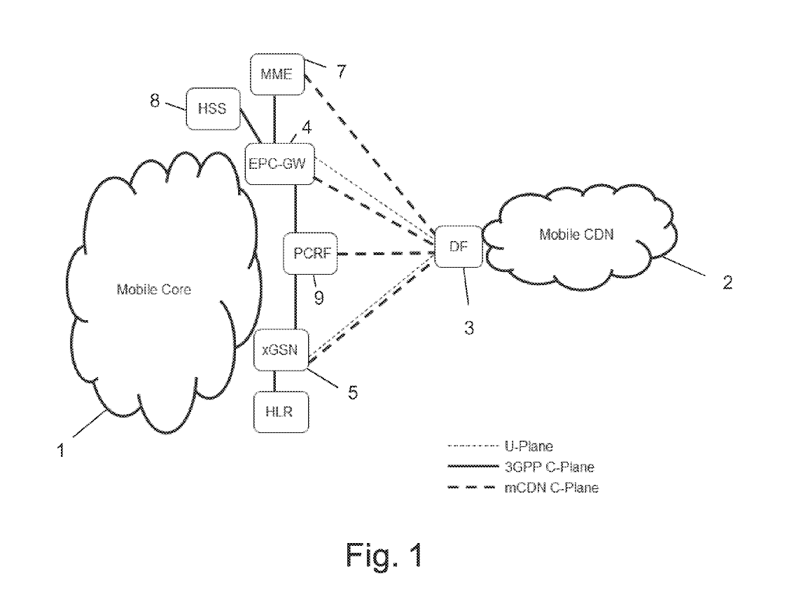

FIG. 1 schematically illustrates a network core 1 (hereinafter denoted as mobile core) of a mobile communication network according to a 3GPP architecture as well as a mobile content delivery network 2 (hereinafter briefly denoted as mCDN). The different components of mobile core 1, which will be described in more detail below, communicate with each other on the 3GPP C-Plane (control plane), as indicated by the continuous lines.

According to an embodiment of the present invention, control plane information from the mobile core 1 is used within the internal request routing algorithms of the mCDN 2. As will be appreciated by those skilled in the art, the embodiment of the present invention is generic in the sense that it can be applied to many different kinds of mobile CDN systems. Further, as already mentioned above, the embodiment of the present invention is also applicable to other types of communication networks, such as, but not limited to, fixed-line networks, as long as these networks provide control plane information, or similar information.

Specifically, FIG. 1 shows the interactions between control plane functions (hereinafter briefly denoted as C-Plane functions) of mobile core 1 and the mCDN 2. During the initial request of relevant content by a user terminal, the terminal (or UE, User Equipment, in 3GPP terminology) of the user gets assigned a DF (Delivery Function) 3 as entry point in the mobile CDN system 2. As indicated in FIG. 1 by the dotted lines, the DF 3 communicates on the U-Plane (user plane) with the EPC-GW (Evolved Packet Core Gateway) 4 and with the xGSN 5 of mobile core 1. Further, as indicated by the dashed lines, the DF 3 can query C-Plane information from the mobile core 1 through proprietary interfaces or standard interfaces. The embodiment of the present invention is independent of which interface type is being used/deployed.

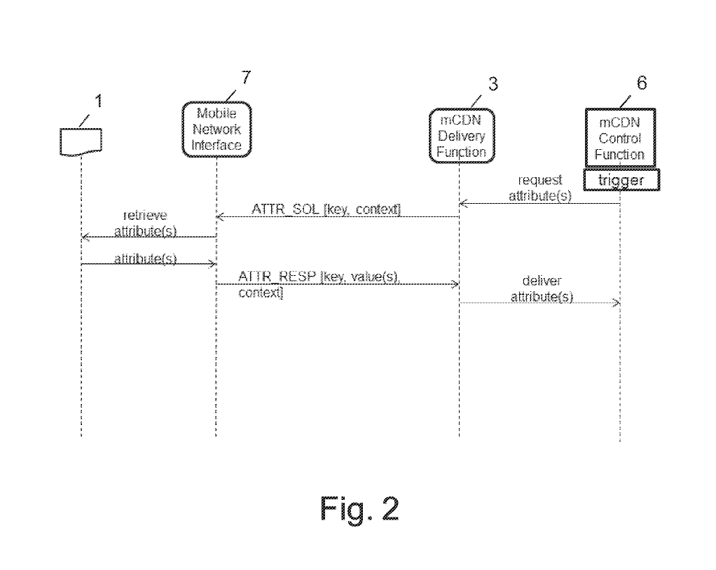

Turning now to FIG. 2, which illustrates a model for attribute solicitation from the 3GPP C-Plane by the DF 3 of the mCDN system 2 according to an embodiment of the invention. This model enables the DF 3 to query for certain attributes regarding a specific UE.

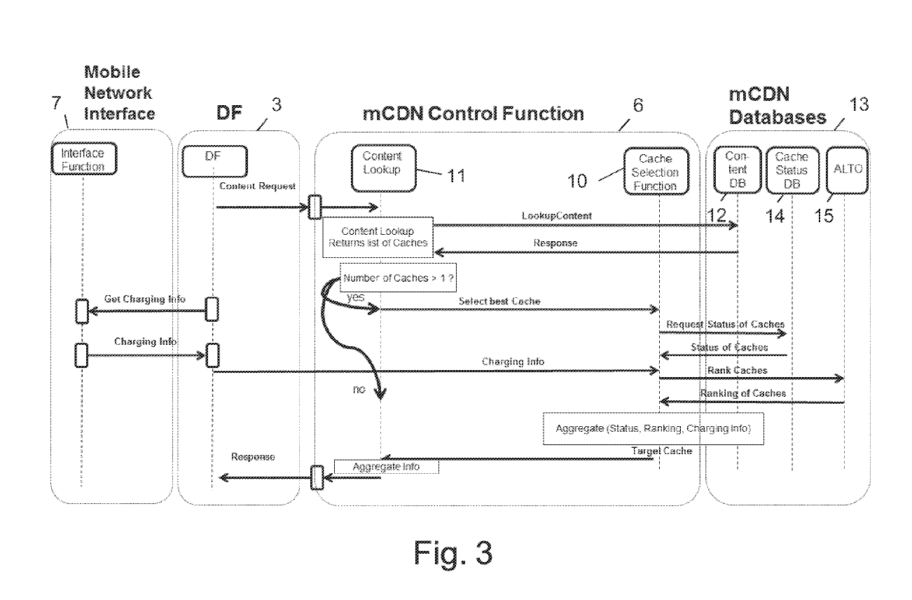

According to the embodiment illustrated in FIG. 2, a control function 6 is implemented inside the mCDN 2. Upon receiving a respective trigger, e.g. in form of the receipt of a content request at the mCDN 2, the control function 6 requests particular attributes from DF 3. In a next step, DF 3 selects an appropriate mobile network interface 7 and solicits the requested attributes from this interface 7 by transmitting an attribute solicitation message (ATTR_SOL) towards this interface 7. Certain parameters may be included within this message, like a key and/or context information. Mobile network interface 7 retrieves the requested attributes from locations in the mobile core 1, where the respective information is available, and returns the values of the requested attributes to DF 3, for instance by way of using an ATTR_RESP message. DF 3 delivers the attributes to the mCDN control function 6, where the information is further processed, as will be described in more detail in connection with FIG. 3 below.

In particular, according to preferred embodiments of the invention, Policy (QoS) and Charging information is solicited from the C-Plane of mobile core 1 for optimized CDN request routing, in particular the selection of the best cache in the network.

The following is an overview of QoS and Charging information about a content requesting end-user that is, in general, available via the interfaces partly shown in FIG. 1:
Granted/Negotiated QoS (“QoS IE”):
available at xGSN 5
Granted QoS (“EPS Bearer QoS”):
available at MME 7, SGW, PGW
Subscribed QoS:
   Subscribed UE AMBR (Aggregate Maximum Bit Rate):
   available at MME 7, HSS 8
   Subscribed APN AMBR (Aggregate Maximum Bit Rate):
   available at MME 7, HSS 8
   EPS subscribed QoS profile:
   available at MME 7, HSS 8
Subscribed Charging Characteristics
   EPS Subscribed Charging Characteristics (Normal, prepaid, flat-rate or hot billing subscription):
   available at MME 7, HSS 8
   EPS PDN Subscribed Charging Characteristics (Normal, prepaid, flat-rate or hot billing subscription):
   available at MME 7, HSS 8, SGW, PGW.

According to a further embodiment, the above mentioned charging information, which is particularly useful to be integrated into the best cache selection process, can be retrieved from the mobile core 1 by taking advantage of the Policy and Charging Control functionality in the 3GPP architecture (also referred to as “PCC architecture”) as described in 3GPP TS 23.203 V11.5.0 (2012-03): “3rd Generation Partnership Project; Technical Specification Group Services and System Aspects; Policy and charging control architecture (Release 11)”. For instance, the “Policy and Charging Rules Function (PCRF)” 9 as part of the control plane of mobile core 1 could be enhanced such that it provides an interface through which the mCDN 2 could solicit charging control information (e.g. according to embodiment described in connection with FIG. 2).

FIG. 3 illustrates an embodiment of an integration of C-Plane information into a cache selection process in a generic mCDN architecture. Even though for the purpose of clarity the illustrated embodiment is exemplarily restricted to charging information, it will be easily appreciated by those skilled in the art that other kind of information available via the control plane of mobile core 1 can be integrated likewise into the cache selection process. In the embodiment of FIG. 3, the following steps are executed:
1. Upon having received a content request from a UE, the DF 3 solicits charging information regarding this UE.
2. The DF 3 passes this information on to the cache selection process of the CDN request routing, specifically to a Cache Selection function 10 which is part of the mCDN control function 6. Is
3. From a Content Lookup function 11, which is also part of the mCDN control function 6, the Cache Selection function 10 receives information which caches store the desired content. The Content Lookup function 11 receives this information from a content database 12, which is part of a central mCDN database 13.
4. For those caches which have the desired content, the Cache Selection function 10 fetches a) information about their status (e.g. from a central cache status database 14) as well as b) topology/policy information regarding which caches are currently preferable from a network layer perspective, e.g. from an Application-Layer Traffic Optimization (ALTO) server 15.
5. In its internal algorithm, the Cache Selection function 10 combines and/or aggregates the information received in steps 2 and 4 and returns the best cache to the DF 3. One example for aggregating such information could be a weighted sum which can balance conflicting interests in a controllable way.

Using access network specific characteristics like QoS or Charging information about a user within mCDN internal Cache Selection algorithms in accordance with embodiments of the present invention described above comes along with several advantages. For instance, the granted or subscribed QoS of a UE can provide a mCDN insight on how much bandwidth the content request will actually consume. This information is useful to consider for cache selection (in combination with other information) because it allows the mCDN to estimate the resulting internal CDN traffic from this UE. For instance, if a user has low granted QoS, and the otherwise closest/best cache has high load, the mCDN might consider directing the content request to a less close but also less loaded cache because there will anyway not be much data transmitted due to the low QoS granted to the UE. This low granted QoS may also lead to the fact that the service request is rejected, e.g., if the content would require a much better QoS treatment than given by the granted QoS. To summarize, mobile subscriber related information can be used to decide whether a service request can be fulfilled or must be rejected and redirected to the origin server with potentially less QoS.

Charging information can be exploited to prioritize certain subscribers with respect to serving requests from the CDN. For instance, there can be an agreement between an external CDN provider or a mobile CDN provider linked to the mobile network operator, and the mobile operator prioritizes requests from certain customers (e.g. flatrate users) compared to others (e.g. pre-paid users) or certain contents (e.g., a pay per use Video on Demand CDN). For instance, if ALTO and cache load information (which the mCDN provider has available) indicate that the underlay links to close caches are too saturated to handle all requests from a certain DF or the otherwise most suitable caches are too loaded to handle all request from a certain DF, the request routing might solicit charging information from the mobile core and consequently redirect requests from high priority users (according to their charging information) to “good caches” resulting in low delay, and redirect other users to “second-choice” caches with higher delay. Another possibility is to preempt low priority users completely in case of highly loaded caches.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for performing mobile CDN request routing, comprising:
receiving, from a user terminal attached or subscribed to a communication network, a content request initiated by the user terminal towards a mobile content delivery network (mCDN),
processing the content request within the mCDN by selecting a cache at which the requested content is available, and
making internal mCDN request routing decisions based on control plane information from the network core of the communication network.

2: The method according to claim 1, wherein the user terminal, upon initiating an initial content request towards the mCDN, gets assigned a delivery function as an entry point into the mCDN.

3: The method according to claim 2, wherein the delivery function queries the control plane information from the network core through proprietary or standard interfaces.

4: The method according to claim 1, wherein the control plane information includes information related to the user terminal.

5: The method according to claim 1, wherein the control plane information includes information related to granted or negotiated QoS of the user terminal.

6: The method according to claim 1, wherein the control plane information includes information related to subscribed QoS of the user terminal.

7: The Method according to claim 1, wherein the control plane information includes information related to subscribed charging characteristics of the user terminal.

8: The method according to claim 1, wherein subscriber information about the user terminal is employed by the mCDN to retrieve policy or charging information about the user terminal.

9: The method according to claim 8, wherein the subscriber information about the user terminal is obtained by an application function residing within the mCDN based on the user terminal's IP address.

10: The method according to claim 1, wherein a cache selection function of the mCDN combines or aggregates information related to the user terminal with internal mCDN specific information.

11: The method according to claim 10, wherein an algorithm is applied for best cache selection which takes into consideration the combined or aggregated information.

12: A system for performing mobile CDN request routing, comprising
a communication network including a network core,
a mobile content delivery network (mCDN), and
a user terminal attached or subscribed to the communication network and configured to initiate a content request towards the mCDN,
wherein the mCDN is configured to process the content request by selecting a cache at which the requested content is available,
and wherein the mCDN includes a control function configured to collect control plane information from the network core and to take into consideration the control plane information for making internal mCDN request routing decisions.

13: The system according to claim 12, wherein the communication network is a mobile communication network comprising a mobile core network.

14: The system according to claim 12, wherein the mCDN includes a delivery function configured to solicit information related to a content requesting user terminal.

15: The system according to claim 12, wherein the control function includes a cache selection function and a content lookup function.

16: The system according to claim 15, wherein the content lookup function is configured to receive, from a central content database, information about which caches store requested content and to forward the information to the cache selection function.

17: The system according to claim 16, wherein the cache selection function is configured to fetch information about a status of the caches which store the requested content.

18: The system according to claim 17, wherein the cache selection function is configured to fetch topology or policy information about the caches which store requested content.

19: The method according to claim 8, wherein the mCDN retrieves policy or charging information about the user terminal via a Policy and Charging Rules Function (PCRF) of a mobile core network of the communication network.

20: The system according to claim 18, wherein the cache selection function is configured to fetch the topology or policy information about the caches which store requested content by contacting an Application-Layer Traffic Optimization (ALTO) server.
